(19) United States
(12) Patent Application Publication
(10) Pub. No.: US 2025/0390361 A1
(43) Pub. Date: Dec. 25, 2025

(54) COHERENT CONTAINERIZED COMPUTING

(71) Applicant: Red Hat, Inc., Raleigh, NC (US)

(72) Inventors: Pierre-Yves Chibon, Puteaux (FR); Paul Wallrabe, Grasbrunn (DE)

(21) Appl. No.: 18/748,602

(22) Filed: Jun. 20, 2024

(51) Int. Cl. G06F 9/54

(52) U.S. Cl. CPC G06F 9/542; G06F 9/547

(57) ABSTRACT

Aspects of the present disclosure relate to coherent containerized computing. More specifically, a method is described that includes obtaining an indication of a workload and an indication of an event. The method further includes mapping the event to a first container in a plurality of containers, where each container in the plurality of containers is configured for a different processor architecture, and where the first container is configured for a first processor architecture. The method also includes performing, by a first processing device configured with the first processor architecture, the workload by way of the first container.

### TECHNICAL FIELD

Aspects of the present disclosure relate to containers, and more particularly, to coherent containerized computing.

### BACKGROUND

Containers are active components executing on an operating system that provide an environment for applications to run, while being isolated from other components of a host machine, network, data center, etc. Multiple containers may execute on a single operating system (OS) kernel and share resources of hardware on which the operating system runs. Files, libraries, and dependencies for running an application in a container may be provided by image file(s). An image file (which may also be referred to as a “container image”) may include a set of base layers that defines a runtime environment, as well as packages and utilities used for a containerized application to run. A container may include the base layers from an image file, as well as an in-memory layer in which the containerized application may write/modify data.

### BRIEF DESCRIPTION OF THE DRAWINGS

The described aspects and the advantages thereof may best be understood by reference to the following description taken in conjunction with the accompanying drawings. These drawings in no way limit any changes in form and detail that may be made to the described aspects by one skilled in the art without departing from the spirit and scope of the described aspects.

FIG. 1 is a block diagram that illustrates an example of a system in accordance with some aspects of the present disclosure.

FIG. 2 is a block diagram that illustrates an example of ensuring data consistency in coherent containerized computing in accordance with some aspects of the present disclosure.

FIG. 3 is a block diagram that illustrates an example of a system in accordance with some aspects of the present disclosure.

FIG. 4 is a flow diagram of a method for coherent containerized computing in accordance with some aspects of the present disclosure.

FIG. 5 is a block diagram of an example of a computer system that may perform one or more of the operations described herein in accordance with some aspects of the present disclosure.

### DETAILED DESCRIPTION

Containers are active components executing on an operating system that provide an environment for applications to run, while being isolated from other components of a host machine, network, data center, etc. Multiple containers may execute on a single operating system (OS) kernel and share resources of hardware on which the operating system runs. Files, libraries, and dependencies for running an application in a container may be provided by image file(s). An image file (which may also be referred to as a “container image”) may include a set of base layers that defines a runtime environment, as well as packages and utilities used for a containerized application to run. A container may include the base layers from an image file, as well as an in-memory layer in which the containerized application may write/modify data.

A container may be configured for more than one processor architecture. An image for such a container may be referred to as a “multiple architecture container image,” a “multi-architecture container image,” or a “multi-arch container image.” A multi-arch container image may include a list of container images that includes references to binaries and libraries compiled for a plurality of processor architectures. In an example, a multi-arch container image may include first binaries and libraries for a first type of processor architecture (e.g., x86 architecture) and second binaries and libraries for a second type of processor architecture (e.g., advanced reduced instruction set computer machines (ARM®) architecture). A processing device configured with/having a particular processor architecture may execute a container configured for the particular processor architecture.

Coherent computing may refer to an integrative approach to processing in which multiple different computing architectures collaboratively handle workloads. Coherent computing may leverage strengths of different processor architectures (e.g., x86_64 and AArch64) while mitigating their respective weaknesses. In an example with respect to coherent computing, a device (e.g., a vehicle, a server, etc.) includes a first processing device configured with a first processor architecture and a second processing device configured with a second processor architecture. The first processor architecture and the second processor architecture may be suited for different tasks and/or for performing a task in different manners. In an example, the first processing device may consume a first amount of power when performing a workload and the second processing device may consume a second amount of power when performing the workload, where the first amount of power is less than the second amount of power. In another example, the first processing device may be capable of executing a first number of applications (e.g., newer applications) and the second processing device may be capable of executing a second number of applications (e.g., newer applications and legacy applications), where the second number of applications is greater than the first number of applications

Utilizing coherent computing in a containerized workload context may be associated with several issues. For example, a multi-arch container image may provide for containers that run on different processor architectures, but some coherent computing approaches may not be capable of dynamically and efficiently allocating workloads to the containers based on conditions associated with the workloads and/or the device(s) that execute the workloads. Furthermore, some coherent computing approaches may not address data consistency issues in a container context. With more particularity, if two distinct containers corresponding to two distinct processor architectures attempt to access the same data in shared memory simultaneously (e.g., as part of executing a containerized workload), lag and/or data corruption may occur.

The present disclosure addresses the above-noted and other deficiencies by using a processing device for coherent containerized computing for containerized workloads. In an example, a computing device obtains an indication of a workload and an indication of an event (e.g., a battery level of the computing device, a temperature level of the computing device, etc.). The computing device maps the event to a first container in a plurality of containers, where each container in the plurality of containers is configured for a different processor architecture, and where the first container is configured for a first processor architecture. A first processing device configured with the first processing architecture performs the workload by way of the first container. Vis-à-vis mapping the event to the first container that is configured for the first processor architecture and performing, by the first processing device, the workload by way of the first container, the computing device may conserve resources. For instance, if the event indicates a low battery level and the first processing device is a low power processing device, performing the workload by the first processing device may conserve battery life of the computing device. Conversely, if the event indicates a high battery level and the first processing device is a high power processing device that has a relatively high amount of computational power, performing the workload by the first processing device may enable the workload to be performed in a more efficient manner (e.g., fewer clock cycles).

Additionally, in some aspects, subsequent to performing the mapping, a second processing device of the computing device that is configured with a second processor architecture may implement a lock on an address range of a data structure in memory (i.e., shared memory) by way of a second container that is configured for the processor architecture. The second processing device may perform a remote procedure call (RPC) request to the first container by way of the second container. The first processing device may perform the workload based on the RPC request. The first processing device may then perform an RPC response to the second container by way of the first container. The RPC response may be indicative of the performed workload. The first processing device may release, based on the RPC response, the lock by way of the first container. Vis-à-vis the aforementioned RPC response/RPC request procedure, the computing device may ensure that the first processing device and the second processing device have a consistent view of data in the shared memory, which may prevent corruption of the data and/or lag.

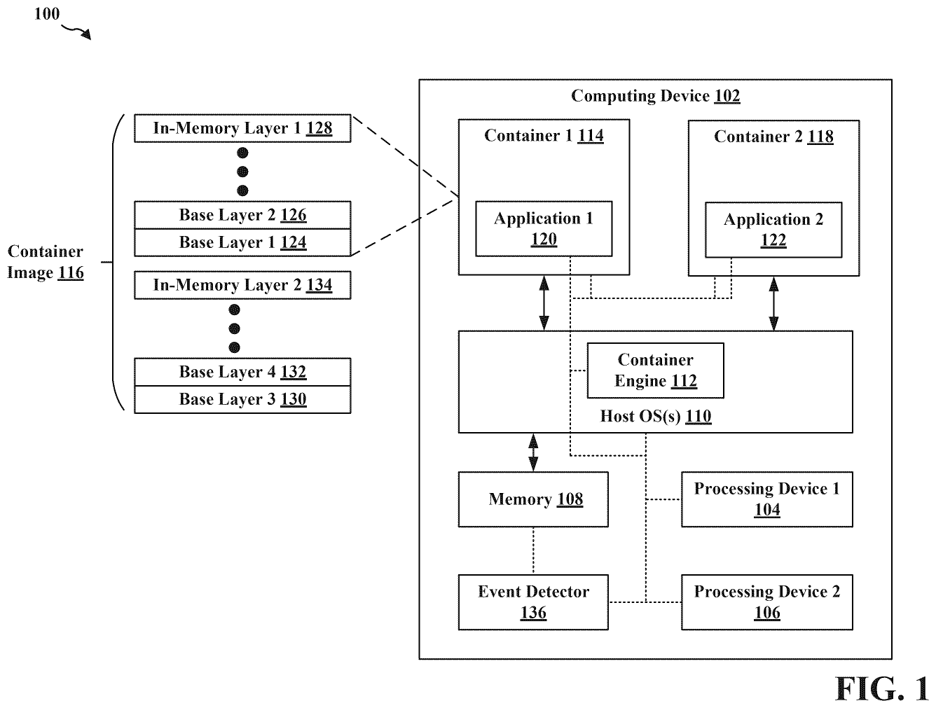

FIG. 1 is a block diagram 100 that illustrates an example of a system in accordance with some aspects of the present disclosure. The system includes a computing device 102. The computing device 102 may include any suitable type of computing device or machine that has programmable processors including, for example, server computers, desktop computers, laptop computers, tablet computers, smartphones, gaming consoles, set-top boxes, etc. In one example, the computing device 102 is or is included in a vehicle, such as a car, a truck, a motorcycle, a boat, a spacecraft, etc.

The computing device 102 includes a first processing device 104 configured for (i.e., including) a first processor architecture and a second processing device 106 configured for (i.e., including) a second processor architecture, where the first processor architecture and the second processor architecture are different. The first processor architecture may include a first layout, a first instructions set, a first number of cores, a first clock speed, a first memory, first input devices, and first output devices, whereas the second processor architecture may include a second layout, a second instructions set, a second number of cores, a second clock speed, a second memory, second input devices, and second output devices. In one example, the first processor architecture is a complex instruction set computer (CISC) architecture and the second processor architecture is a reduced instruction set computer (RISC) architecture. In another example, the first processing device 104 is an x86 processor and the second processing device 106 is an ARM® processor. In one example, the first processing device 104 is a first system-on-chip (SoC) and the second processing device 106 is a second SoC. In a further example, the first processing device 104 is a SoC and the second processing device 106 is a central processing unit (CPU), or vice versa.

The first processing device 104 and the second processing device 106 may be configured with/include/be associated with different characteristics. In one example, the first processing device 104 and the second processing device 106 are associated with different power consumptions. In another example, the first processing device 104 and the second processing device 106 are associated with different performance levels. For instance, the first processing device 104 may perform a workload in a first number of processor clock cycles and the second processing device 106 may perform the workload in a second number of processor clock cycles, where the first number of processor clock cycles and the second number of processor clock cycles are different. In a further example, the first processing device 104 and the second processing device 106 may be configured to execute different numbers of applications. For instance, the first processing device 104 may be configured to execute a wide variety of applications (e.g., applications developed within the last thirty years), whereas the second processing device 106 may be configured to execute recently developed (e.g., within the past ten years) applications. Although the computing device 102 is depicted as including two processing devices, the concepts described herein may be applicable to a number of processing devices that is greater than two (e.g., three, four, etc.).

The computing device 102 includes memory 108 (e.g., random access memory (RAM), storage devices (e.g., a hard-disk drive (HDD)), and solid-state drives (SSD), etc.), and other hardware devices (e.g., a sound card, video card, etc.). A storage device may include a persistent storage that is capable of storing data. A persistent storage may be a local storage unit or a remote storage unit. Persistent storage may be a magnetic storage unit, an optical storage unit, a solid state storage unit, electronic storage units (main memory), or a similar storage unit. Persistent storage may also be a monolithic/single device or a distributed set of devices.

The computing device 102 may execute or include operating system(s) (OS(s)), such as host OS(s) 110 within the memory 108. The host OS(s) 110 may refer to OS(s) of the computing device 102 that interface directly with hardware (e.g., the first processing device 104, the second processing device 106, the memory 108, etc.) of the computing device 102. For instance, the host OS(s) 110 may execute directly on the hardware of the computing device 102. The host OS(s) 110 of the computing device 102 may manage the execution of other components (e.g., software, applications, etc.) and/or may manage access to the hardware (e.g., processors, memory, storage devices, etc.) of the computing device 102. In an example, the host OS(s) 110 may include a first host OS configured for the first processor architecture of the first processing device 104 and a second host OS configured for the second processor architecture of the second processing device 106.

The computing device 102 may execute a container engine 112 that executes on top of the host OS(s) 110. The computing device 102 may also execute a first container 114. For instance, the container engine 112 may instantiate and execute the first container 114 based on a container image 116 (described in greater detail below). With more particularity, the container engine 112 may obtain the container image 116 and convert the container image 116 into a running instance (e.g., the first container 114) of the container image 116. Instantiating the first container 114 may include assigning/allocating resources to the first container 114. Instantiating the first container 114 may also include retrieving the container image 116 from a container image repository (e.g., a server), preparing a container mount point (e.g., a copy-on-write storage), preparing metadata used to start the first container 114, and calling a container runtime that runs the first container 114. The container engine 112 may allow for different containers to share elements (e.g., an OS kernel, packages, binaries, libraries, source files, etc.) of the host OS(s) 110. The container engine 112 may also facilitate interactions between the first container 114 and the resources of the computing device 102. For example, the container engine 112 may manage requests from the first container 114 to access the memory 108 (e.g., shared memory) of the computing device 102. In another example, the container engine 112 may manage requests from the first container 114 to access certain packages of the host OS(s) 110. The container engine 112 may also create, remove, and/or manage containers. In one aspect, the container engine 112 may be a component of the host OS(s) 110 (e.g., Red Hat™ Enterprise Linux). In another embodiment, the container engine 112 may run on top of the host OS(s) 110, or the container engine 112 may run directly on host hardware without the use of the host OS(s) 110. In other aspects, the container engine 112 may be a component of a network virtualization platform (not shown), such as the RedHat™ OpenStack™ platform, that runs on the host OS(s) 110. The container engine 112 may include software or logic to build a container using a container image such as a docker file. The first container 114 may be isolated, that is, the first container 114 may not be connected to other devices or components of the computing device 102. In some aspects, the container engine 112 may be implemented as a first container engine and a second container engine, where the first container engine is configured for the first processor architecture and the second container engine is configured for the second processor architecture. The first container engine may execute on the first host OS (of the host OS(s) 110) and the second container engine may execute on the second host OS (of the host OS(s) 110) The first container engine and the second container engine may communicate with one another.

The computing device 102 may also execute a second container 118. For instance, the container engine 112 may instantiate and execute the second container 118 based on the container image 116 (described in greater detail below). The second container 118 may be similar to the first container 114 described above; however, the first container 114 is configured for the first processor architecture of the first processing device 104, whereas the second container 118 is configured for the second processor architecture of the second processing device 106. Stated differently, the first container 114 may include instructions that are executable by a processor having the first processor architecture, whereas the second container 118 may include instructions that are executable by a processor having the second processor architecture. The first processing device 104 may execute the first container 114 and the second processing device 106 may execute the second container 118.

In some aspects, the first container 114 includes a first application 120 and the second container 118 includes a second application 122. The first application 120 may execute within the first container 114 and the second application 122 may execute within the second container 118. For example, the first application 120 may execute within a runtime environment (i.e., a container runtime) of the first container 114 and the second application 122 may execute within a runtime environment (i.e., a container runtime) of the second container 118. In one aspect, the first application 120 and/or the second application 122 may be associated with performing a workload of the computing device 102. In an example, the workload may be associated with navigation of a vehicle, reporting data to another computing device, receiving data from another computing device, or processing data gathered by sensor(s) associated with the computing device 102. In some aspects, the first application 120 and the second application 122 may be configured to execute the same workload in a different manner to produce the same result due to varying characteristics (e.g., different power consumptions) between the first processing device 104/first container 114 and the second processing device 106/second container 118.

As noted above, the container engine 112 may instantiate and execute the first container 114 and/or the second container 118 based on the container image 116. The container image 116 may be stored in computer-readable storage (e.g., the memory 108). The container image 116 may be a multi-arch container image, that is, the container image 116 may be a single image that includes variants for different processor architectures.

The container image 116 may include a first base layer 124 and a second base layer 126 that define a runtime environment as well as packages and utilities necessary for a containerized application (e.g., the first application 120) to run. In an example, the first base layer 124 may include a host OS (including, for example, the OS kernel as well as the packages of the host OS, including any associated libraries, binaries, and/or source files, etc.) on which the first application 120 may run. The second base layer 126 may include the first application 120 itself, including any packages and utilities necessary for the first application 120 to run. Thus, the first base layer 124 and the second base layer 126 may each include static snapshots of a configuration of the container image 116 and may be read-only layers that are not modified. The container image 116 may also include a first in-memory layer 128 that may be a read/write layer.

Changes (e.g., data written by the first application 120) associated with the first container 114 may be stored in the first in-memory layer 128.

The container image 116 may include a third base layer 130 and a fourth base layer 132 that define a runtime environment as well as packages and utilities necessary for a containerized application (e.g., the second application 122) to run. In an example, the third base layer 130 may include a host OS (including, for example, the OS kernel as well as the packages of the host OS, including any associated libraries, binaries, and/or source files, etc.) on which the second application 122 may run. The fourth base layer 132 may include the second application 122 itself, including any packages and utilities necessary for the second application 122 to run. Thus, the third base layer 130 and the fourth base layer 132 may each include static snapshots of a configuration of the container image 116 and may be read-only layers that are not modified. The container image 116 may also include a second in-memory layer 134 that may be a read/write layer. Changes (e.g., data written by the second application 122) associated with the second container 118 may be stored in the second in-memory layer 134. Although not depicted in FIG. 1, the container image 116 may include any number of base layers (e.g., one base layer, five base layers, ten base layers, etc.) for each container (e.g., for the first container 114 and for the second container 118). Although the description above has described the container image 116 as being a multi-arch container image, other possibilities are contemplated. In some aspects, a first container image provides the first container 114 and a second container image provides the second container 118.

The computing device 102 may communicate with other devices over a network (not depicted in FIG. 1). The network may be a public network (e.g., the Internet), a private network (e.g., a local area network (LAN) or a wide area network (WAN)), or a combination thereof. In one example, the network may include a wired or a wireless infrastructure, which may be provided by one or more wireless communications systems, such as a WiFi™ hotspot connected with the network and/or a wireless carrier system that can be implemented using various data processing equipment, communication towers (e.g., cell towers), etc. The network may carry communications (e.g., data, messages, packets, frames, etc.) between the computing devices.

The computing device 102 may further include an event detector 136. The event detector 136 is configured to detect an event or to receive an indication of a detected event. The event may be or include an event that is internal to the computing device 102 (e.g., detecting a temperature of the computing device 102 or a component thereof, such as the first processing device 104 or the second processing device 106) or an event that is external to the computing device 102 (e.g., detecting a temperature of an ambient environment of the computing device 102). The event may also be or include characteristics of a workload that to be executed by the computing device 102. The event detector 136 may be implemented in hardware, software, firmware, or a combination thereof. The event detector 136 may be or include sensor(s). In an example, the sensor(s) may include a temperature sensor (e.g., a sensor that measures an internal temperature of the computing device 102 or a component thereof, a sensor that measures a temperature external to the computing device 102), a battery life sensor, a barometer, an inertial measurement unit (IMU), an altimeter, a light sensor, a microphone, a camera, etc. The event detector 136 may be coupled to, in communication with, or associated with one or more of the first processing device 104, the second processing device 106, the memory 108, the host OS(s) 110, the container engine 112, the first container 114, the first application 120, the second container 118, or the second application 122. In some aspects, the event detector 136 includes a network interface (not depicted in FIG. 1) that enables the event detector 136 to communicate (i.e., receive data, transmit data) over a network. In an example, an event detected by the event detector 136 may be or include a battery level of a battery of a device (or a change in the battery level), a temperature level of the device (or a changed in the temperature level of the device, a partial hardware failure of the device, or a computational load of a workload, where the device may be or include the computing device 102.

The computing device 102 may obtain an indication of a workload and an indication of an event. In an example, the event is an event detected by the event detector 136. In some aspects, the computing device 102 may receive the indication of the event from a source external to the computing device 102. In an example, the workload may be or include one or more of the workloads described above. In an example, the event may be or include one or more of the events described above.

The computing device 102 may map the event to a container in a plurality of containers. In an example, the plurality of containers includes the first container 114 and the second container 118. The plurality of containers may also include additional containers (not depicted in FIG. 1). Each container in the plurality of containers may be configured for a different processor architecture. For instance, the first container 114 may be configured for a first processor architecture of the first processing device 104 and the second container 118 may be configured for a second processing architecture of the second processing device 106. In an example, the computing device 102 maps the event to the first container 114. The first processing device 104 may perform the workload by way of the first container 114.

In some aspects, the computing device 102 may maintain a table (not depicted in FIG. 1) in the memory 108 that includes indications of events and of containers configured for different processing architectures. The events and the containers are associated with one another within the table. The computing device 102 may map the event to the first container 114 based on an association in the table.

Although the computing device 102 has been described above as mapping the event to a container in a plurality of containers in which each container is configured for a different processor architecture, other possibilities are contemplated. In one aspect, the computing device 102 may map the event to a processor architecture in a plurality of processor architectures. The computing device 102 may then select a container configured for the processor architecture and perform, by way of the selected container, the workload with a processing device configured with the processor architecture. In another aspect, the computing device 102 may map the event to a processing device in a plurality of processing devices, where each processing device is configured with a different processor architecture. The computing device 102 may then select a container configured for the processing device and perform, by way of the selected container, the workload with the processing device.

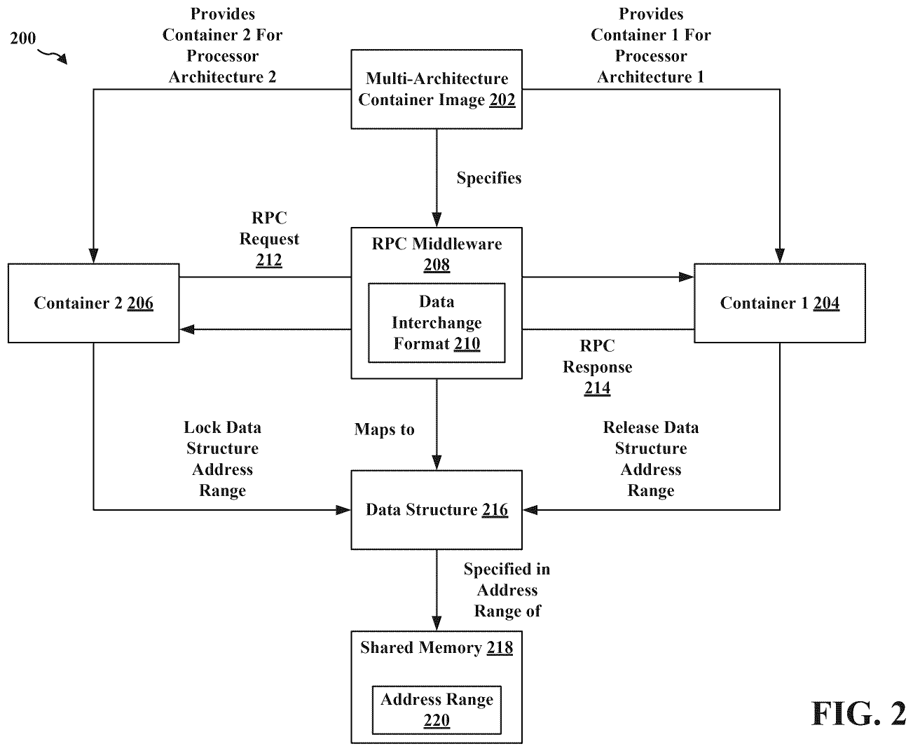

FIG. 2 is a block diagram 200 that illustrates an example of ensuring data consistency in coherent containerized computing in accordance with some aspects of the present disclosure. A computing device (e.g., the computing device 102) may be provided with a multi-architecture container image 202. The multi-architecture container image 202 provides a first container 204 for a first processor architecture and a second container for a second processor architecture. With more particularity, the computing device may instantiate and execute the first container 204 and the second container 206 based on the multi-architecture container image 202. In an example, the multi-architecture container image 202 may be or include the container image 116, the first container 204 may be or include the first container 114 and the second container 206 may be or include the second container 206. The first container 204 and the second container 206 may include a first application (e.g., the first application 120) and a second application (e.g., the second application 122)

The multi-architecture container image 202 may include/specify remote procedure call (RPC) middleware 208. An RPC may refer to a form of inter-process communication (IPC) in that different processes have different address spaces. An RPC may refer to a computer program causing a procedure to execute in a different address space. In an example, the RPC middleware 208 may be included in the first container 204, the second container 206, another container associated with the multi-architecture container image 202, an application, or a combination thereof. The RPC middleware 208 may include a data interchange format 210 that enables the first container 204 (and hence a first processing device, such as the first processing device 104) and the second container 206 (and hence a second processing device, such as the second processing device 106) to communicate with another. In an example, the data interchange format 210 may define a serialization process that enables data to be converted to a bitstream and the bitstream to be converted back to the data. The first processing device/first container 204 may transmit the bitstream to the second processing device/second container 206, whereupon the second processing device/second container 206 may reconstruct the data using the serialization process, or the second processing device/second container 206 may transmit the bitstream to the first processing device/first container 204, whereupon the first processing device/first container 204 may reconstruct the data using the serialization process.

It is contemplated that the first container 204 is to perform a workload. In an example, a computing device (e.g., the computing device 102) executing the first container 204 may map an event to the first container 204 in a manner similar to that described above with respect to FIG. 1. In some aspects, the second container 206 may have previously been executing workloads, and the event may cause the computing device 102 to switch to the first container 204 to execute the workload (described in greater detail below). In some aspects, the first container 204 is running when the event is mapped or detected. In other aspects, the first container 204 is instantiated and executed upon the event being mapped or detected.

Upon obtaining an indication that the workload is to be performed by the first container 204, the second container 206 may implement a lock on an address range 220 of a data structure 216 in shared memory 218. The shared memory 218 may be shared between the first container 204/first processing device and the second container 206/second processing device. The lock may be implemented in hardware and/or software. As such, the lock may be on a data structure level, an object level, or a resource level. The lock may prevent the data structure 216 from being modified by the second container 206. In some aspects, the RPC middleware 208 may map to the data structure 216, and the lock may be based upon the mapping. Upon implementing the lock, the second container 206 may perform an RPC request 212 to the first container 204 by way of the data interchange format 210 of the RPC middleware 208. With more particularity, the second container 206 may transmit the RPC request 212 to the first container 204 based on the data interchange format 210 of the RPC middleware 208. The RPC request 212 may be indicative of the workload that is to be performed. The first container may receive the RPC request 212 based on the data interchange format 210.

Upon receiving the RPC request 212, the first container 204 may perform the workload (e.g., based on an indication of the workload in the RPC request 212). In some aspects, performing the workload may include the first container 204 reading and/or writing data to the data structure 216 (e.g., based on the mapping of the RPC middleware 208 to the data structure 216).

Subsequent to performing the workload, the first container 204 may perform an RPC response to the second container 206 by way of the data interchange format 210 of the RPC middleware 208. With more particularity, the first container 204 may transmit the RPC response 214 to the second container 206 based on the data interchange format 210 of the RPC middleware 208. The RPC response 214 may be indicative of the performed workload. In some aspects, the RPC response 214 may include a result of the performed workload. The second container 206 may receive the RPC response 214 based on the data interchange format 210. The first container 204 may release the lock on the data structure 216 (e.g., based on performing the RPC response 214). Releasing the lock may enable the second container 206 to modify the data structure 216.

Although the description of FIG. 2 describes the second container 206 as initiating the RPC request 212 and locking the address range 220 of the data structure 216 in the shared memory 218 and the first container 204 as initiating the RPC response 214, performing the workload, and releasing the lock on the address range 220, other possibilities are contemplated. In some aspects, the first container 204 initiates the RPC request 212 and locks the address range 220 of the data structure 216 in the shared memory 218 and the second container 206 initiates the RPC response 214, performs the workload, and releases the lock on the address range 220.

Some aspects presented herein pertain to using multi-architecture container images to differentiate between x86_64 and AArch64 processor architectures during container delivery and to embed functionality pertaining to ensuring data consistency across diverse processor architectures and to allocate tasks (i.e., workloads) to different containers executing on different processor architectures based on characteristics of the different processor architectures and/or events.

In one aspect described herein, data consistency may be ensured across diverse processor architectures by managing memory access and by ensuring that different processors having different architectures have a consistent view of data. This may prevent or mitigate data corruption and/or lag that might otherwise occur when two or more distinct processor architectures attempt to access and modify data simultaneously. In such an aspect, a container image may include remote procedure call (RPC) based middleware that abstracts complexities of inter-process communication in which a procedure of a first SoC calls a procedure of a second SoC (i.e., a remote SoC). Data synchronization may be performed through a shared memory that includes an addressed space that is locked by a calling SoC during the RPC in order to ensure that only one SoC is able to write data at a time. In some scenarios, the lock on the address space may be a read lock that is based on a context. The RPC middleware may include or may be associated with a data interchange format that is based on structs (i.e., data structures) used in an application. Thus, the lock may be a lock on a struct, an object, or a resource of a computing device.

In another aspect described herein, workloads may be allocated to containers configured for different processor architectures based on characteristics of the different processor architectures and/or events. In such an aspect, for each type of RPC, a default processor architecture may be added as a default. A computing device may dynamically allocate workloads based on events (e.g., a low charge level on a battery of the computing device, cooling properties of the computing device, etc.). With more particularity, the computing device may be configured to map an event or a series of events to a processor architecture. A processing device configured with the processor architecture may execute the workload on a container configured for the processor architecture based on the mapping.

In an example, in a coherent computing system, an x86_64 processor may handle workloads characterized by raw computational power demands or workloads that utilize the mature x86_64 software ecosystem. Simultaneously, an AArch64 processor may handle workloads characterized by relatively low power consumption and/or workloads that are intended to be power efficient. According to aspects described herein, containers configured for x86_64 and AArch64 can be used to change a mode of operation of a system that includes the x86_64 processor and the AArch64 processor. For example, based on a battery level of a battery of the system, temperature and cooling characteristics of the system, or based on a load of the system, the system may allocate a workload to a container configured for a suitable processor architecture. While the example described above focuses on an x86_64 processor and an AArch64 processor, the concepts described herein may be applicable to other types and combinations of processor architectures.

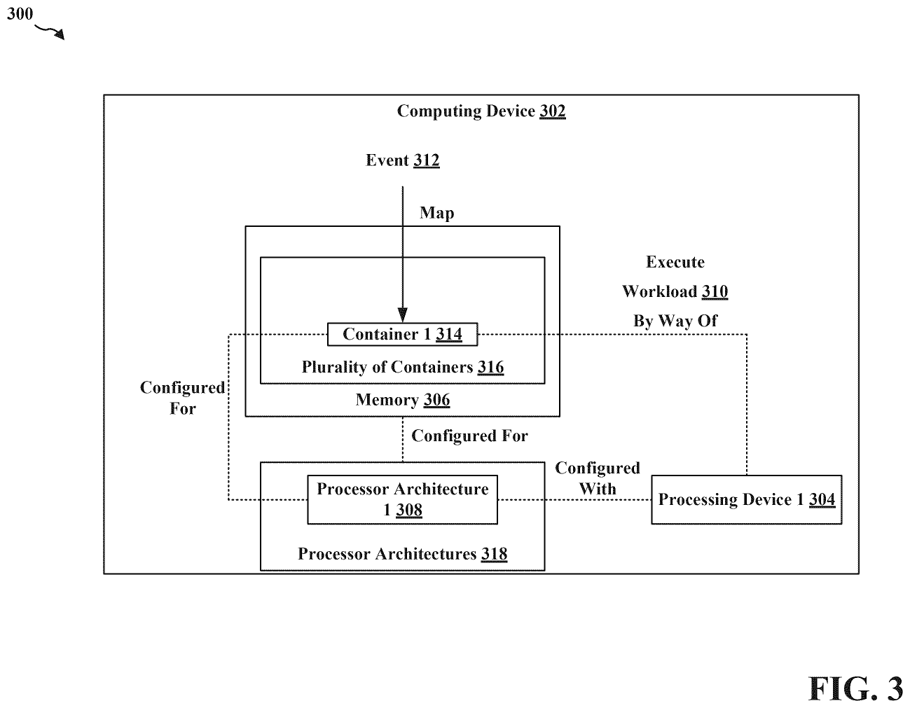

FIG. 3 is a block diagram 300 that illustrates an example of a system in accordance with some aspects of the present disclosure. The system includes a computing device 302. The computing device 302 includes a first processing device 304 and a memory 306. The first processing device 304 is operatively coupled to the memory 306. The first processing device 304 is configured with a first processor architecture 308.

The computing device 302 (e.g., by way of the first processing device 304) obtains an indication of a workload 310 and an indication of an event 312. The computing device 302 (e.g., by way of the first processing device 304) maps the event 312 to a first container 314 in a plurality of containers 316. Each container in the plurality of containers 316 is configured for different processor architectures 318. The first container 314 is configured for the first processor architecture 308. As such, the computing device 302 may include a plurality of processing devices (not depicted in FIG. 3) that includes the first processing device 304, where each of the plurality of processing devices is configured for a different processor architecture. The first container 314 may be stored in the memory 306. The first processing device 304 performs the workload 310 by way of the first container 314.

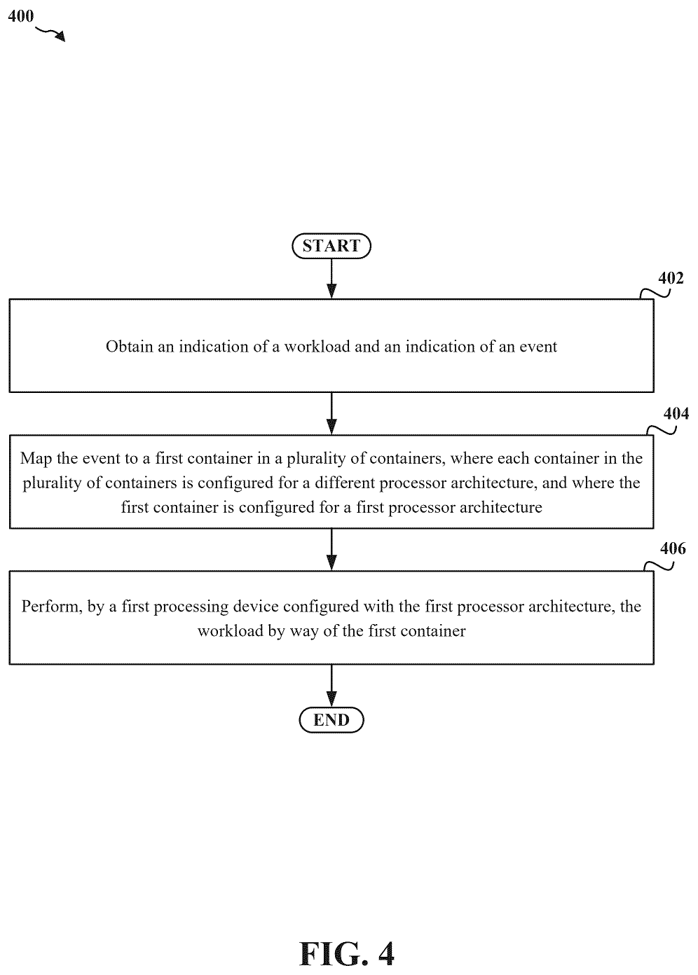

FIG. 4 is a flow diagram of a method 400 for coherent containerized computing in accordance with some aspects of the present disclosure. The method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some aspects, the method 400 may be performed by a computing device (e.g., computing device 102 in FIG. 1, the computing device 302 in FIG. 3). In some aspects, the method 400 (or a portion thereof) may be performed by the first processing device 104 and/or the second processing device 106. In some aspects, the method 400 (or a portion thereof) may be performed by the first processing device 304.

At block 402, a processing device (e.g., a first processing device configured with a first processor architecture or a second processing device configured with a second processor architecture) obtains an indication of a workload and an indication of an event. In an example, the workload may be or include the workload 310 and the event may be or include the event 312.

At block 404, a processing device (e.g., a first processing device configured with a first processor architecture or a second processing device configured with a second processor architecture) maps the event to a first container in a plurality of containers, where each container in the plurality of containers is configured for a different processor architecture, and where the first container is configured for the first processor architecture. In an example, the first container may be the first container 114, the first container 204, or the first container 314. In an example, the plurality of containers may include the first container 114 and the second container 118. In another example, the plurality of containers may include the first container 204 and the second container 206. In a further example, the plurality of containers may be or include the plurality of containers 316.

At block 406, the first processing device configured with the first processor architecture performs the workload by way of the first container.

In some aspects, the event may include at least one of a battery level of a battery of a device (e.g., a computing device), a temperature level of the device, a partial hardware failure of the device, or a computational load of the workload.

In some aspects, the second processing device configured with the second processor architecture may implement a lock on an address range of a data structure in shared memory by way of a second container in the plurality of containers, where the second container is configured for the second processor architecture. In some aspects, the lock may be a hardware lock or a software lock. The second processing device may also perform an RPC request to the first container by way of the second container based on the lock. Performing the workload may be based upon the RPC request. The RPC request may indicate the address range and the workload, and performing the workload may be based on the address range. The RPC request may be performed based on a data interchange format defined between the first processor architecture and the second processor architecture. The aforementioned aspect may correspond to FIG. 2.

In some aspects, the first processing device may perform an RPC response to the second container by way of the first container subsequent to the first processing device performing the workload. The RPC response may be indicative of the performed workload. The first processing device may release, based upon the RPC response, the lock on the address range of the data structure in the shared memory by way of the first container. The aforementioned aspect may correspond to FIG. 2.

In some aspects, the first processing device may include a RISC architecture and the second processing device includes a CISC architecture. In some aspects, the first processing device may include a CISC architecture and the second processing device includes a RISC architecture.

In some aspects, the first container and the second container may be included in a multi-architecture container image. In some aspects, the first container and the second container may be capable of performing the workload.

In some aspects, a processing device (e.g., a first processing device configured with a first processor architecture or a second processing device configured with a second processor architecture) may obtain an indication of a second instance of the workload and an indication of a second event that is different from the event. The processing device (e.g., a first processing device configured with a first processor architecture or a second processing device configured with a second processor architecture) may map the second event to the second container in the plurality of containers. The second processing device configured with the second processor architecture may perform the second instance of the workload by way of the container.

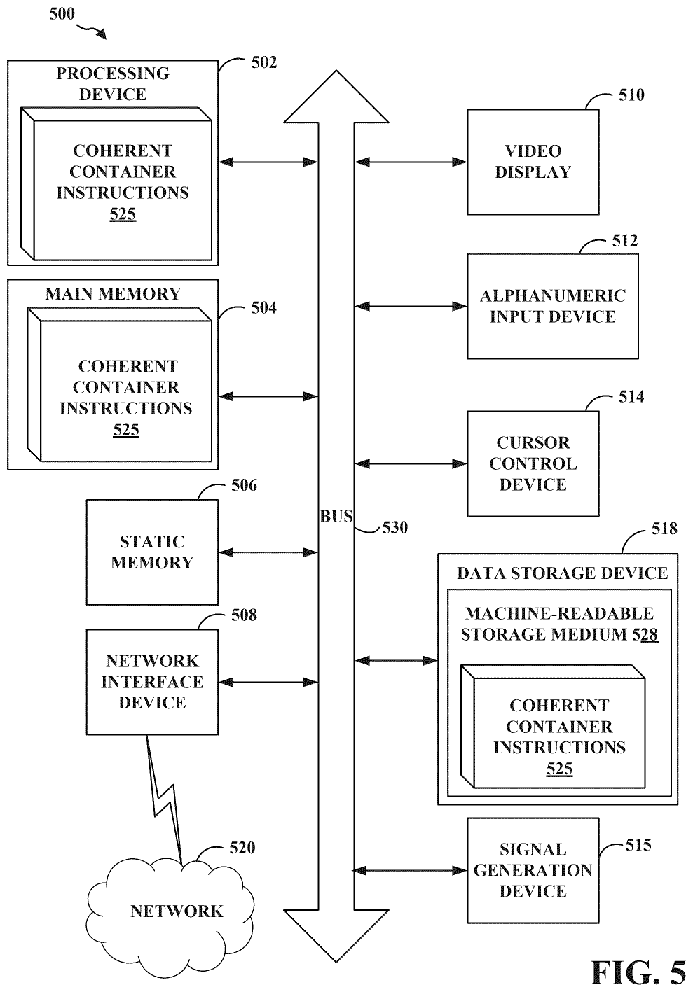

FIG. 5 illustrates a diagrammatic representation of a machine in the example form of a computer system 500 within which a set of instructions, for causing the machine to perform any one or more of the methodologies discussed herein for coherent containerized computing. More specifically, the machine may obtain an indication of a workload and an indication of an event; map the event to a first container in a plurality of containers, where each container in the plurality of containers is configured for a different processor architecture, and where the first container is configured for a first processor architecture; and perform, by a first processing device configured with the first processor architecture, the workload by way of the first container.

In alternative aspects, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or a bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one aspect, the computer system 500 may be representative of a server or a vehicle.

The computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., a speaker). In one example, the video display unit 510, the alphanumeric input device 512, and the cursor control device 514 may be combined into a single component or device (e.g., an LCD touch screen).

The processing device 502 represents one or more general-purpose processing devices such as a microprocessor, a central processing unit, or the like. More particularly, the processing device 502 may be a complex instruction set computing (CISC) microprocessor, a reduced instruction set computer (RISC) microprocessor, a very long instruction word (VLIW) microprocessor, or a processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), a network processor, or the like. The processing device 502 is configured with coherent container instructions 525, for performing the operations and steps discussed herein. For example, the coherent container instructions 525 may include instructions for obtaining an indication of a workload and an indication of an event; mapping the event to a first container in a plurality of containers, where each container in the plurality of containers is configured for a different processor architecture, and where the first container is configured for a first processor architecture; and performing, by a first processing device configured with the first processor architecture, the workload by way of the first container.

The data storage device 518 may include a machine-readable storage medium 528 storing coherent container instructions 525 (e.g., software) embodying any one or more of the methodologies of functions described herein. The coherent container instructions 525 may also reside, completely or partially, within the main memory 504 or within the processing device 502 during execution thereof by the computer system 500; the main memory 504 and the processing device 502 also constituting machine-readable storage media. The coherent container instructions 525 may further be transmitted or received over the network 520 via the network interface device 508.

The machine-readable storage medium 528 may also be used to store the coherent container instructions 525 to perform a method for coherent containerized computing, as described herein. While the machine-readable storage medium 528 is shown in an exemplary aspect to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, a magnetic storage medium (e.g., floppy diskette), an optical storage medium (e.g., CD-ROM), a magneto-optical storage medium, a read-only memory (ROM), random-access memory (RAM), erasable programmable memory (e.g., EPROM and EEPROM), flash memory, or another type of medium suitable for storing electronic instructions.

The preceding description sets forth numerous specific details such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular aspects may vary from these exemplary details and still be contemplated to be within the scope of the present disclosure.

Additionally, some aspects may be practiced in distributed computing environments where the machine-readable medium is stored on and or executed by more than one computer system. In addition, the information transferred between computer systems may either be pulled or pushed across the communication medium connecting the computer systems.

Aspects of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another aspect, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” or “an implementation” or “one implementation” throughout is not intended to mean the same aspect or implementation unless described as such. Furthermore, the terms “first,” “second,” “third,” “fourth,” etc. as used herein are meant as labels to distinguish among different elements and may not necessarily have an ordinal meaning according to their numerical designation. Unless specifically stated otherwise, terms such as “obtaining,” “mapping,” “performing,” “implementing,” “releasing,” “receiving,” “executing,” “transmitting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass aspects in hardware, software, or a combination thereof.

What is claimed is:

1. A method, comprising:
obtaining an indication of a workload and an indication of an event;
mapping the event to a first container in a plurality of containers, wherein each container in the plurality of containers is configured for a different processor architecture, and wherein the first container is configured for a first processor architecture; and
performing, by a first processing device configured with the first processor architecture, the workload by way of the first container.

2. The method of claim 1, wherein the event comprises at least one of:
a battery level of a battery of a device;
a temperature level of the device;
a partial hardware failure of the device; or
a computational load of the workload.

3. The method of claim 1, further comprising:
implementing, by a second processing device configured with a second processor architecture, a lock on an address range of a data structure in shared memory by way of a second container in the plurality of containers, wherein the second container is configured for the second processor architecture; and
performing, by the second processing device and based on the lock, a remote procedure call (RPC) request to the first container by way of the second container, wherein performing the workload is based upon the RPC request.

4. The method of claim 3, wherein the RPC request indicates the address range and the workload, and wherein performing the workload is based on the address range.

5. The method of claim 3, further comprising:
performing, by the first processing device and subsequent to performing the workload, an RPC response to the second container by way of the first container, wherein the RPC response is indicative of the performed workload; and
releasing, by the first processing device and based upon the RPC response, the lock on the address range of the data structure in the shared memory by way of the first container.

6. The method of claim 3, wherein the lock comprises at least one of a hardware lock or a software lock.

7. The method of claim 3, wherein the first processing device includes a reduced instruction set computer (RISC) architecture and the second processing device includes a complex instruction set computer (CISC) architecture.

8. The method of claim 3, wherein the first processing device includes a complex instruction set computer (CISC) architecture and the second processing device includes a reduced instruction set computer (RISC) architecture.

9. The method of claim 3, wherein performing the RPC request comprises performing the RPC request based on a data interchange format defined between the first processor architecture and the second processor architecture.

10. The method of claim 3, wherein the first container and the second container are included in a multi-architecture container image.

11. The method of claim 3, wherein the first container and the second container are capable of performing the workload.

12. The method of claim 3, further comprising:
obtaining an indication of a second instance of the workload and an indication of a second event that is different from the event;
mapping the second event to the second container in the plurality of containers; and
performing, by the second processing device, the second instance of the workload by way of the second container.

13. A system, comprising:
a memory; and
a first processing device configured with a first processor architecture, the first processing device operatively coupled to the memory to:
obtain an indication of a workload and an indication of an event;
map the event to a first container in a plurality of containers, wherein each container in the plurality of containers is configured for a different processor architecture, and wherein the first container is configured for the first processor architecture; and
perform the workload by way of the first container.

14. The system of claim 13, wherein the event comprises at least one of:
a battery level of a battery of a device;
a temperature level of the device;
a partial hardware failure of the device; or
a computational load of the workload.

15. The system of claim 13, further comprising a second processing device with a second processor architecture, the second processing device operatively coupled to the memory to:
implement a lock on an address range of a data structure in the memory by way of a second container in the plurality of containers, wherein the second container is configured for the second processor architecture; and
perform, based on the lock, a remote procedure call (RPC) request to the first container by way of the second container, wherein to perform the workload, the first processing device is to perform the workload based upon the RPC request.

16. The system of claim 15, wherein the RPC request indicates the address range and the workload, and wherein to perform the workload, the first processing device is to perform the workload based on the address range.

17. The system of claim 15, wherein the first processing device is further to:
perform, subsequent to performance of the workload, an RPC response to the second container by way of the first container, wherein the RPC response is indicative of the performed workload; and
release, based on the RPC response, the lock on the address range of the data structure in the memory by way of the first container.

18. The system of claim 15, wherein to perform the RPC request, the second processing device is to perform the RPC request based on a data interchange format defined between the first processor architecture and the second processor architecture.

19. A non-transitory computer-readable medium having instructions stored thereon which, when executed by a first processing device configured with a first processor architecture, cause the first processing device to:
obtain an indication of a workload and an indication of an event;
map the event to a first container in a plurality of containers, wherein each container in the plurality of containers is configured for a different processor architecture, and wherein the first container is configured for the first processor architecture; and
perform, by the first processing device, the workload by way of the first container.

20. The non-transitory computer-readable medium of claim 19, wherein the event comprises at least one of:
a battery level of a battery of a device;
a temperature level of the device;
a partial hardware failure of the device; or
a computational load of the workload.
